(19) United States
(12) Patent Application Publication
(10) Pub. No.: US 2025/0052347 A1
(43) Pub. Date: Feb. 13, 2025

(54) Multipurpose Hose Clamp

(71) Applicant: Willie Louis Johnson, Detroit, MI (US)

(72) Inventor: Willie Louis Johnson, Detroit, MI (US)

(21) Appl. No.: 18/927,111

(22) Filed: Oct. 25, 2024

Related U.S. Application Data
(63) Continuation-in-part of application No. 17/488,756, filed on Sep. 29, 2021, now abandoned.
(60) Provisional application No. 63/125,639, filed on Dec. 15, 2020.

(51) Int. Cl. F16L 33/08

(52) U.S. Cl. CPC F16L 33/08

(57) ABSTRACT

The present invention relates to a multipurpose hose clamp. The hose clamp is capable of rotating laterally in a 360-degree orientation in clockwise and counterclockwise directions. The multipurpose clamp includes a round, flat, thin, single-gear band, and a clamping device. The clamping device is separable from the band. An adjusting component is configured to twist or turn into the clamping device and engages the slots disposed on the band to increase or decrease a diameter of the hose clamp. The multipurpose clamp can be applied to any type of hose, for example, water hoses, automobile hoses, radiator hoses, air vent hoses, etc. The adjusting component is perpendicularly oriented to the single-gear band.

### CROSS-REFERENCE TO RELATED APPLICATION

The present application is a Continuation-In-Part application and claims priority to, and the benefit of U.S. application Ser. No. 17/488,756 which was filed on Sep. 29, 2021 and claims priority to and the benefit of U.S. Provisional Patent Application No. 63/125,639, which was filed on Dec. 15, 2020 both of which are incorporated herein by reference in their entirety.

### FIELD OF THE INVENTION

The present invention relates generally to hose clamps or band clamps. More specifically, the present invention relates to a hose clamp or band clamp that easily attaches and detaches from any type of hose. The hose clamp includes a round, flat, thin, single-gear band, a separate screw and a screw cage or worm gear. The hose clamp is designed to rotate 360-degrees both clockwise and counterclockwise in a horizontal direction, and remains accessible from any angle while working with a hose. The hose clamp provides convenience, safety and ease of work for an operator while working with the hose clamp even in hard-to-reach areas for securing around a hose or hose mount. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, hose clamps are commonly used to be mounted on a hose end, in order to fasten the hose to connecting components such as a nipple, barb or a tube mount. Hose clamps generally help to prohibit moving fluid from escaping from around a hose mount or hose connection configuration. Hose clamps or band clamps are used in household applications, automobile applications and industries, particularly concentrated in the chemical, food and marine markets. Most typical hose clamps heretofore known are worm drive hose clamps and are generally manufactured of galvanized iron.

Hose clamps typically comprise a clamp band. Terminal ends of the band, for example, at the ends of a formed open ring or loop, can be closed by means of a connecting locking portion and a clamping screw, captive screw or clamping device. In a conventional hose clamp, the clamping device is attached to one end of a band having a screw thread pattern, and the other loose end of the band is inserted in a space between the band and the captive screw. However, conventional hose clamps are fixed in orientation and cannot be rotated. Hose clamps are also generally placed in hard-to-reach areas having limited working tool space, thus the use of the currently available hose clamps is incredibly difficult and time-consuming due to rotation and orientation restrictions.

Further, conventional hose clamps have a screw cage or worm gear configuration having one end of the band that contains a clamping device. When the screw is turned, it acts as a worm drive, pulling the threads of the band together, causing the band to shorten and tighten around the hose. Screw clamps are normally used for hoses ½ inch in diameter and larger, with other clamp types used for smaller hoses. However, to reach a hose clamp, an operator needs to remove extra parts or layers of materials to reach the hose clamp on any type of hose. Reaching the hose clamp is complicated when tools are involved (i.e. a long-handled screwdriver). It is incredibly difficult and time-consuming to install and remove a hose clamp due to rotation and access angle restrictions.

Therefore, there exists a long felt need in the art for a multipurpose hose clamp capable of rotating 360-degrees in clockwise and counterclockwise directions. Additionally, there is a long felt need in the art for a multipurpose hose clamp that enables operators to easily attach and remove the clamp from virtually any type of hose such as water hoses, automobile hoses and much more. Moreover, there is a long felt need in the art for a hose clamp that can be accessible from any angle while working with a hose, which enables a user to apply the clamp and utilize it as needed from any angle. Finally, there is a long felt need in the art for a hose clamp that remains tool-accessible from any angle while working with a hose.

The subject matter disclosed and claimed herein, in one embodiment thereof, comprises a multipurpose hose clamp capable of rotating 360-degrees in clockwise and counterclockwise directions. The multipurpose clamp further can be applied to any type of hose like water hoses, automobile hoses and much more. The multipurpose clamp further includes a round, flat, thin, single-gear band, a clamping device that is detachably attached to the band and a screw. The screw cage is separable and can be connected in a direction perpendicular to the band orientation. The screw cage is designed to rotate 360-degrees in either direction.

In this manner, the novel multipurpose hose clamp device of the present invention accomplishes all of the forgoing objectives and provides a user with a convenient way to access the clamp from any angle, while working with any type of hose like water hoses, automobile hoses and much more. The multipurpose hose clamp device of the present invention eliminates the need to remove parts surrounding a hose clamp while working with a hose, as the screw cage is capable of rotating 360-degrees in clockwise and counterclockwise directions, wherein the user can access the clamp from any angle. Additionally, the user can mount and utilize the clamp as needed from any angle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multipurpose hose clamp. The multipurpose hose clamp is configured to rotate 360 degrees in both clockwise and counterclockwise directions. The hose clamp further comprises a round, flat, thin single-gear band configured to apply around a hose, a screw cage for engaging to the single-gear band, and a screw to insert into the screw cage. The screw when twisted into the screw cage enables the band to fasten around the hose. The screw cage is adapted to engage to the band in any orientation.

In a further embodiment of the present invention, a method of arranging a 360 degree rotatable multipurpose hose clamp is described. The method includes initially providing a round, flat, thin, single-gear band, a screw cage and a threaded screw. The screw cage is designed to attach to the band and is configured to rotate laterally in a 360 degree orientation to the band. The threaded screw is designed to twist or turn into the screw cage in order to shorten the band and to fasten the clamp to a hose in any desired direction and angle.

In yet another embodiment, a method of using a 360 degree rotatable multipurpose hose clamp is described. The method includes initially moving both the ends of the band towards each other, such that a plurality of teeth (i.e. a pair of hooks) of the attachment portion in the first end pass through the slots on the second end of the band. A screw cage can be inserted over the first end of the clamp band in order to engage a terminal end of the claim band inside of the screw cage. Thereafter, the screw cage is placed over the clamp band to connect the clamp ends. The screw cage can be rotated in any desired orientation by laterally rotating the screw cage selectively in clockwise or counterclockwise directions. Finally, a screw can be inserted in the screw cage and turned for adjusting the diameter of the band.

In an additional embodiment, the present invention comprises an adjustable hose clamp. The adjustable hose clamp is configured to secure a hose to a hose mount. The adjustable hose clamp comprises an adjustable band comprising a first end, a second end, and a plurality of slots staggered along a length of the adjustable band. The adjustable hose clamp further comprises an adjusting component cage. The adjusting component cage is movably positioned over a portion of the adjustable band in a perpendicular orientation relative to the adjustable band. The adjustable hose clamp further comprises an adjusting component. The adjusting component comprises a head and a shaft comprising a plurality of teeth extending along a length of the shaft. The adjusting component is insertable into the adjusting component cage and configured to rotate so that the plurality of teeth engage the plurality of slots of the adjustable band to adjust a diameter of the adjustable band.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a multipurpose hose clamp of the present invention in accordance with the disclosed architecture;

FIG. 2 illustrates a perspective view of one potential embodiment of components of the multipurpose hose clamp of the present invention in accordance with the disclosed architecture;

FIG. 3 illustrates a flow diagram showing an operation of the multipurpose hose clamp of the present invention in accordance with the disclosed architecture;

FIG. 4 illustrates a perspective view of one potential embodiment of the multipurpose hose clamp rotated ninety degrees in a clockwise direction to align with the band length in accordance with the disclosed architecture.

FIG. 5 illustrates a perspective view of one potential embodiment of a multipurpose hose clamp of the present invention in accordance with the disclosed architecture;

FIG. 6 illustrates an exploded view of a band, an adjusting component cage, and an adjusting component of the multipurpose hose clamp of the present invention in accordance with the disclosed architecture; and

FIG. 7 illustrates a cut away partial view of the multipurpose hose clamp of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a multipurpose hose clamp, capable of rotating 360 degrees in clockwise and counterclockwise directions. Additionally, there is a long felt need in the art for a multipurpose hose clamp that enables operators to easily attach and remove the clamp from virtually any type of hose such as water hoses, automobile hoses and much more. Moreover, there is a long felt need in the art for a hose clamp that can be accessible from any angle while working with a hose, which enables user to apply the clamp and utilize it as needed from any angle. Finally, there is a long felt need in the art for a hose clamp that remains tool-accessible from any angle while working with a hose.

The present invention, in one exemplary embodiment, comprises a multipurpose hose clamp. The multipurpose hose clamp is configured to selectively rotate 360 degrees in both lateral directions (i.e. clockwise and counterclockwise). The hose clamp further comprises: a round, flat, thin, single-gear band configured to apply around a hose; a screw cage for engaging to the single-gear band; a screw to insert into the screw cage; the screw when twisted into the screw cage enables the band length to shorten (i.e. decrease in diameter) and fasten around the hose; and, the screw cage is adapted to engage to the band in any orientation.

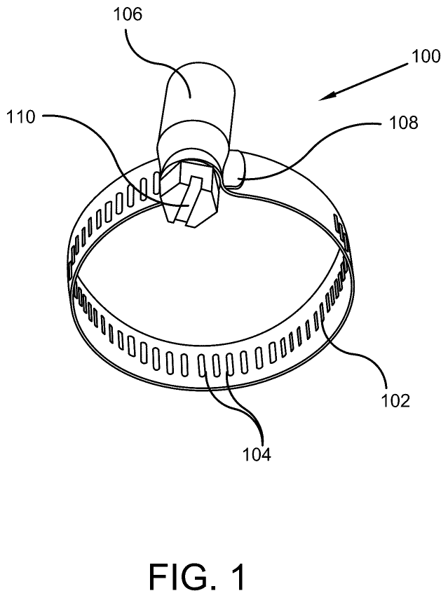

Referring initially to the drawings, FIG. 1 illustrates a perspective view of one potential embodiment of a multipurpose hose clamp of the present invention in accordance with the disclosed architecture. The multipurpose hose clamp 100 of the present embodiment is configured to rotate 360-degrees in both clockwise and counterclockwise directions. The multipurpose hose clamp 100 of the present invention can be applied to any type of hose such as water hoses, automobile hoses, radiator hoses, air vent hoses and much more, to provide a tight seal and to prevent leaks. The hose clamp 100 can be made from a combination of steel, iron, stainless steel, galvanized steel or any other such type of material. The hose clamp 100 can also be made of metallic materials that include a cadmium plating to prevent rust and corrosion.

More specifically, the multipurpose hose clamp 100 includes a round, flat, thin single-gear band 102. The band 102 is configured to be in a circular shape for securing around a circular hose or mount. The diameter of the band 102 increases or decreases as a threaded screw 110 rotates in a clockwise or counterclockwise direction within a screw cage 106. The band 102 engages with the screw cage mechanism 106 for adjusting the diameter of the band 102 by the clamping screw 110. The band 102 includes a plurality of slots 104 that are configured to interact with the screw cage or clamping device 106 and screw 110 to tighten or loosen the hose clamp 100. The band 102 includes an integrated claw shaped attachment 108 at one end of the band 102. When tightening the hose clamp 100, the band 102 moves radially inward and applies a load to a substrate as the screw cage 106 engages the slots 104 staggered along a length of the band 102. When loosening the hose clamp 100, the band 102 moves radially outward as the screw cage 106 disengages from the slots 104 in the band 102.

The screw cage 106 can be made from metallic materials such as, for example, stainless steel. It should be appreciated that the band 102 can be formed from different materials depending on the use of the clamp 100. Such materials may include polymer materials, such as plastic. It should also be appreciated that, although the screw cage 106 is a screw-type mechanism, the hose clamp 100 can include a different screw mechanism such as, for example, a T-bolt or key-bolt mechanism.

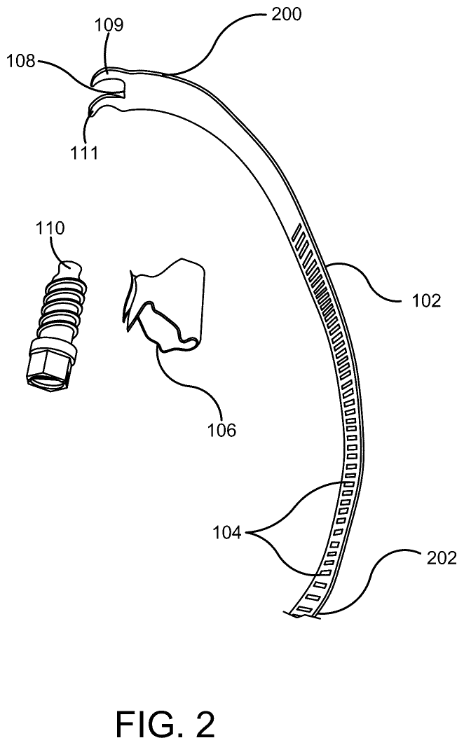

FIG. 2 illustrates a perspective view of components of the multipurpose hose clamp of the present invention in accordance with the disclosed architecture. As shown in FIG. 2, the hose clamp 100 includes a band 102 which can be used to secure any type of hose, for example, water hoses, automobile hoses, radiator hoses, air vent hoses or other types of such hoses, and to provide a tight seal to prevent leaks. The band 102 includes two ends, such as a first end 200 and a second end 202. The first end 200 of the band 102 includes an attachment portion 108 which can be bent so that hooks or teeth 109, 111 of the attachment portion can pass through the plurality of the slots 104 on the second end 202 of the band 102.

The screw cage 106 is separable from the band, and can be connected in a direction generally perpendicular to the band orientation. The screw cage 106 can be inserted over the clamp band 102 to connect both the ends 200, 202 of the band 102. Once the first end 200 of the band 102 passes through the slots 104 on the second end 202 of the band 102, the screw cage 106 can be inserted in the first end 200, in order to engage the material on the inside of the screw cage. The screw cage 106 can rotate on the band 102 in a 360-degree clockwise or counterclockwise direction.

The band 102 length can be adjusted by means of the screw cage 106 cooperating with the clamping screw 110. The diameter of the band 102 can be adjusted by the clamping screw 110 cooperating with the slots 104, such that when the threaded screw 110 rotates, clockwise or counterclockwise, the enclosing diameter of the band 102 decreases or increases, respectively.

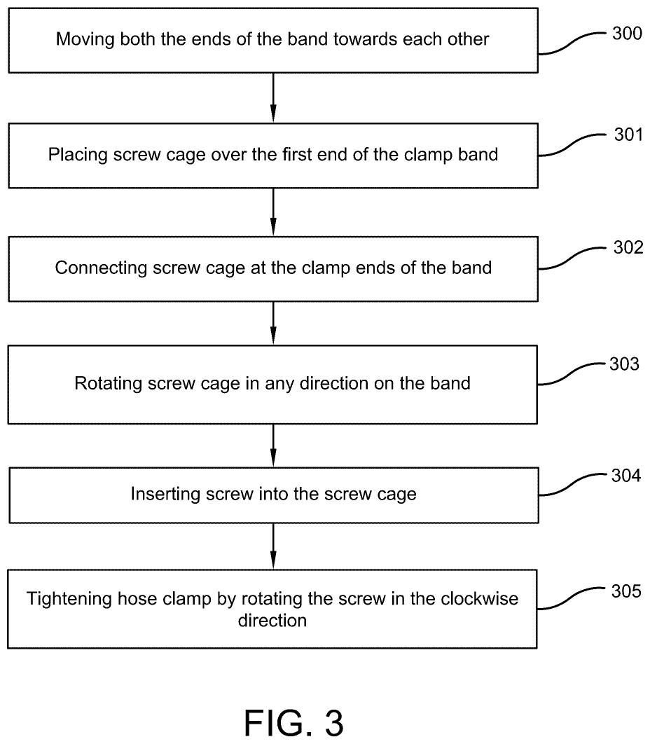

FIG. 3 illustrates a flow diagram showing an operation of the multipurpose hose clamp of the present invention in accordance with the disclosed architecture. As shown, initially both the ends of the band are moved towards each other, such that the teeth or hooks of the attachment portion in the first end are passed through the slots on the second end of the band (Block 300). Then, the screw cage is inserted over the first end of the clamp band in order to engage both of the band ends on the inside of the screw cage (Block 301). The screw cage can be placed over the clamp band in a generally orthogonal orientation relative to the band, in order to connect the band (i.e. clamp) ends (Block 302). The screw cage can be rotated in 360 degree clockwise and counterclockwise directions (Block 303). The screw cage can be connected in a generally orthogonal direction relative to the band orientation. Once the screw cage is at the desired position, the screw can be inserted in the screw cage and then turned in order to adjust the diameter of the band (Block 304). The hose clamp can be tightened by rotating the screw in the clockwise direction. As the screw rotates in clockwise or counterclockwise directions, the enclosing diameter of the band decreases or increases (Block 305), respectively.

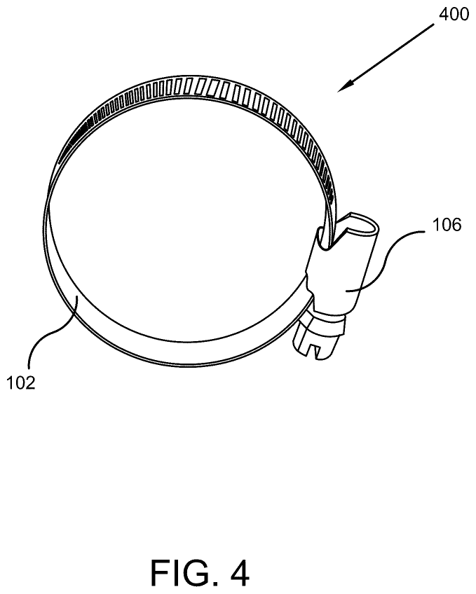

FIG. 4 illustrates a perspective view of the multipurpose hose clamp rotated generally ninety degrees in a clockwise direction to align with the band length in accordance with the disclosed architecture. As shown in FIG. 4, the multipurpose hose clamp 400 can be rotated ninety degrees laterally in the clockwise direction. The hose clamp 400 screw cage 106 can rotate ninety degrees on the band 102 in the clockwise (or counterclockwise) direction, to align with the orientation of the band length. When the screw cage 106 is placed over the clamp band 102 to connect the band ends, the screw cage can be rotated in a ninety degree orientation in clockwise counterclockwise directions.

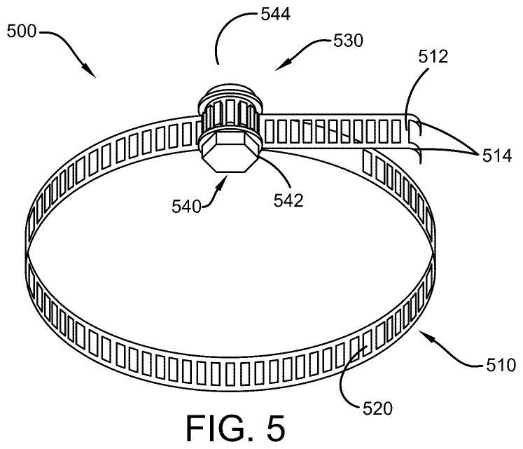

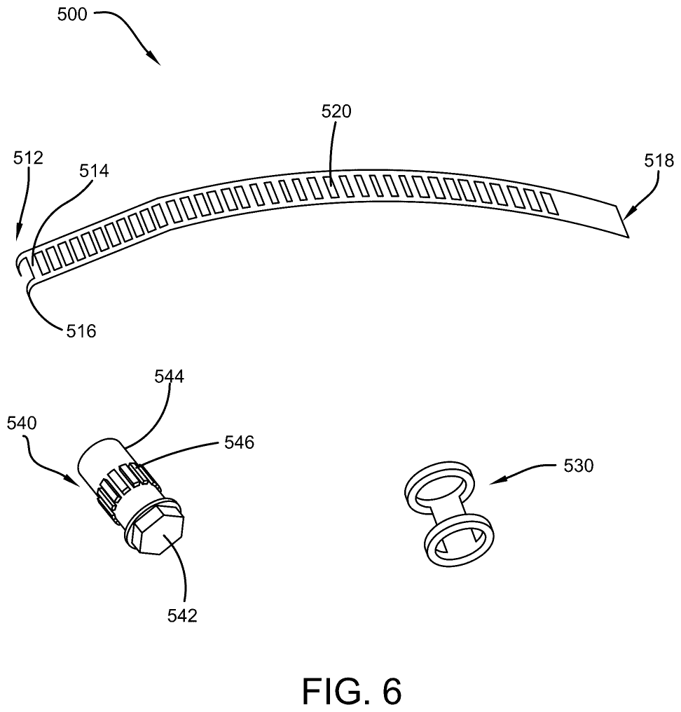

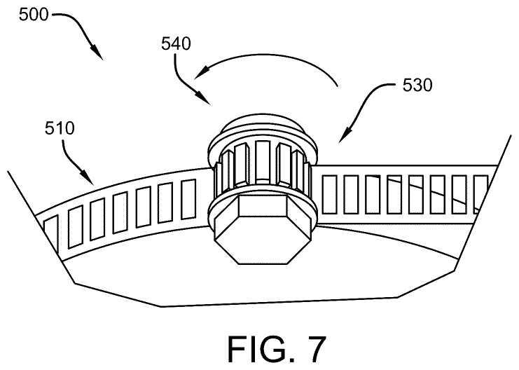

FIGS. 5-7 illustrate a perspective view of another embodiment of an adjustable hose clamp 500 of the present invention in accordance with the disclosed architecture. The adjustable hose clamp 500 of the present embodiment is configured to secure a hose to a hose mount and can be applied to any type of hose such as water hoses, automobile hoses, radiator hoses, air vent hoses and much more, to provide a tight seal and to prevent leaks.

The adjustable hose clamp 500 comprises an adjustable band 510. The adjustable band 510 is configured to be in a circular shape for securing around a circular hose or mount. The adjustable band 510 comprises a first end 512, a second end 518, and a plurality of slots 520. The plurality of slots 520 are staggered along a length of the adjustable band 510. The plurality of slots 520 are typically equidistant from each other. However, the plurality of slots 520 may also get closer to or further from each other moving from the second end to the first end. The adjustable band 510 may be a polymer, plastic, rubber, or metal band. The adjustable band 510 may be reflective or phosphorescent. The adjustable band 510 may be consistent in thickness or the thickness may taper along a length of the adjustable band 510.

The first end 512 of the adjustable band 510 comprises an integrated claw 514. The integrated claw 514 comprises a plurality of hooks 516. The plurality of hooks 516 are bent inward and configured for engaging the plurality of slots 520. More specifically, the plurality of hooks 516 are configured to pass through or over the plurality of slots 512 as the adjustable band 510 is adjusted in diameter and then sit within one of the plurality of slots 512 when the adjustment is complete helping to secure the adjustable hose clamp 500 in place.

The adjustable hose clamp 500 further comprises an adjusting component cage 530. The adjusting component cage 530 is movably positioned over a portion of the adjustable band 510. The adjusting component cage 530 is positioned in a perpendicular orientation relative to the adjustable band 510. The adjusting component cage 530 moves along a length of the adjustable band 510 as it is adjusted in diameter.

The adjustable hose clamp 500 further comprises an adjusting component 540. The adjusting component 540 comprises a head 542 and a shaft 544. The shaft 544 comprises a plurality of teeth 546. The teeth 546 extend along a length of the shaft 544 or may extend a portion of the length of the shaft 544. The teeth 546 are protuberances, ridges, or cogs configured to fit into and engage the slots 512. The shaft 544 may be a cogwheel. The adjusting component 540 is insertable into the adjusting component cage 530 and configured to rotate. The adjustable band 510 and the adjusting component cage 530 may be stainless steel or galvanized steel and may be cadmium plated.

As the adjusting component 540 rotates, the plurality of teeth 546 engage the plurality of slots 512 of the adjustable band 510 to adjust a diameter of the adjustable band 510. Rotating the adjusting component 540 clockwise moves the adjustable band 510 into the adjusting component cage 530 and decreases the diameter of the band 510 to tighten it. Conversely, rotating the adjusting component 540 counter clockwise moves the adjustable band 510 out of the adjusting component cage 530 and increases the diameter of the band 510 to loosen it.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose hose clamp”, “hose clamp”, and “clamp device” are interchangeable and refer to the multipurpose hose clamp 100 of the present invention.

Notwithstanding the forgoing, the multipurpose hose clamp 100 of the present invention can be of any suitable size and configuration as is known in the art without affecting the overall concept of the invention, provided that it accomplishes the above-stated objectives. One of ordinary skill in the art will appreciate that the size, configuration, and material of the multipurpose hose clamp 100 as shown in the FIGS. are for illustrative purposes only, and that many other sizes and shapes of the multipurpose hose clamp 100 are well within the scope of the present disclosure. Although the dimensions of the multipurpose hose clamp 100 are important design parameters for user convenience, the multipurpose hose clamp 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adjustable hose clamp for securing a hose to a hose mount, the adjustable hose clamp comprising:
an adjustable band comprising a first end, a second end, and a plurality of slots staggered along a length of the adjustable band;
an adjusting component cage movably positioned over a portion of the adjustable band in a perpendicular orientation relative to the adjustable band; and
an adjusting component comprising a head and a shaft comprising a plurality of teeth extending along a length of the shaft; and
wherein the adjusting component is insertable into the adjusting component cage and configured to rotate so that the plurality of teeth engage the plurality of slots of the adjustable band to adjust a diameter of the adjustable band.

2. The adjustable hose clamp of claim 1, wherein rotating the adjusting component clockwise moves the adjustable band into the adjusting component cage.

3. The adjustable hose clamp of claim 1, wherein rotating the adjusting component counterclockwise moves the adjustable band out of the adjusting component cage.

4. The adjustable hose clamp of claim 1, wherein the first end comprises an integrated claw.

5. The adjustable hose clamp of claim 4, wherein the integrated claw comprises a plurality of hooks bent inward for engaging the plurality of slots.

6. The adjustable hose clamp of claim 5, wherein the plurality of hooks are configured to pass through the plurality of slots as the adjustable band is adjusted in diameter.

7. The adjustable hose clamp of claim 1, wherein the plurality of slots are equidistant from each other.

8. The adjustable hose clamp of claim 1, wherein the plurality of slots get closer to each other from the second end to the first end.

9. The adjustable hose clamp of claim 1, wherein the adjustable band and the adjusting component cage are stainless steel or galvanized steel.

10. The adjustable hose clamp of claim 1, wherein the adjustable band and the adjusting component cage are cadmium plated.

11. The adjustable hose clamp of claim 1, wherein the adjustable band is a polymer band.

12. The adjustable hose clamp of claim 1, wherein the shaft of the adjusting component is a cogwheel.
